(19) United States
(12) Patent Application Publication
(10) Pub. No.: US 2008/0195715 A1
(43) Pub. Date: Aug. 14, 2008

(54) System and method for asynchronous exchanging electronic messages

(76) Inventors: Tu-Hsin Tsai, Taipei (TW); Chia-I Lin, Taipei (TW); Chun Tai Yen, Taipei (TW)

Correspondence Address: REED SMITH LLP, Suite 1400, 3110 Fairview Park Drive, Falls Church, VA, 22042, US

(21) Appl. No.: 12/068,708

(22) Filed: Feb. 11, 2008

(30) Foreign Application Priority Data
Feb. 14, 2007 (TW) 096105576

(51) Int. Cl. G06F 15/16

(52) U.S. Cl. 709/206

(57) ABSTRACT

A system and a method for asynchronously electronic messages exchanging are disclosed. The system includes a server and more than one clients. Each client has a geographic parameter generator and a message transmitter. The geographic parameter generator is configured to generate a geographic parameter. The message transmitter is configured to transmit the electronic message including a content body and the geographic parameter. The server is composed of a receiver, a database, a matching unit, and a processor. The receiver is configured to receive the electronic message from the clients. The database is used to store the received electronic message. The matching unit compares the geographic parameter of the received message to other existing electronic messages stored in the database according to a set of preset matching rules. A matching list is generated if the match is determined. The processor interacts with at least one of the clients in the matching list.

### CROSS REFERENCE TO RELATED APPLICATIONS

This Application claims the right of priority based on Taiwan Patent Application No. 96105576 entitled “SYSTEM AND METHOD FOR ASYNCHRONOUS EXCHANGING ELECTRONIC MESSAGES” filed on Feb. 14, 2007, which is incorporated herein by reference.

### TECHNICAL FIELD

The present invention relates to a method and a system for managing multimedia electronic messages, and more particularly to a method and a system for asynchronously exchanging electronic messages with geographical location information among a plurality of users in a network.

### BACKGROUND OF THE INVENTION

Various network applications are provided to users based on the well-developed network structure. In addition, providing a communication mechanism for exchanging various kinds of electronic messages becomes more and more important. The message exchanging service has already become a popular service. Based on the various functions provided by the mobile phone, for example, the users may exchange more and more messages including pictures, video, audio, etc.

Traditional message exchanging services, such as e-mail, instant message, SMS message, MMS message, send and/or receive message based on a user account or identifier. This kind of message exchanging service, however, allows users to exchange messages only when they know other user's account. Some other exchanging system, such as BBS or blog, require a unique identifier for users to exchange asynchronous message. In other words, the traditional exchanging process can not provide a flexible and creative exchanging method due to the restrictions of the conventional communication system. However, since the electronic commerce becomes more and more popular, it is advantageous to provide other improved message exchanging method for the increasing demand on various new network applications, such as internet community, forum, etc.

Therefore, it is advantageous to provide a method and a system for exchanging electronic messages in a variety of transmission mechanisms.

### SUMMARY OF THE INVENTION

One aspect of the present invention is to provide a method and a system for asynchronously exchanging electronic messages with geographical location information among users without knowing each other's account.

Another aspect of the present invention discloses a method for asynchronously exchanging electronic messages in a network. The method includes the following steps. An electronic message, having a content body and a geographic parameter, is received from a source client. The received electronic message is stored in a database. The geographic parameter of the received message is compared to other existing electronic messages, each existing electronic message corresponding to a client, stored in the database according to a set of preset matching rules to determine whether there is a match. A matching list is generated if the match is determined. Thereafter, the server interacts with at least one of the corresponding clients in the matching list.

Another aspect of the present invention discloses a system for asynchronously exchanging electronic messages in a network. The system includes a server and one or more clients. Each client has a geographic parameter generator and a message transmitter. The geographic parameter generator is configured to generate a geographic parameter. The message transmitter is configured to transmit the electronic message including a content body and the geographic parameter. The server is composed of a receiver, a database, a matching unit, and a processor. The receiver is configured to receive the electronic message from the clients. The database is used to store the received electronic message. The matching unit compares the geographic parameter of the received message to other existing electronic messages stored in the database according to a set of preset matching rules. A matching list is generated if the match is determined. The processor interacts with at least one of the clients in the matching list.

### BRIEF DESCRIPTION OF THE DRAWINGS

FIG. 1 illustrates a system for asynchronously exchanging electronic messages in accordance with an embodiment of the present invention;

FIG. 2 illustrates a structure of the electronic message in accordance with an embodiment of the present invention;

FIG. 3 is a flowchart illustrating an uploading process of the electronic message in accordance with an embodiment of the present invention;

FIG. 4 illustrates a matching unit in accordance with an embodiment of the present invention;

FIG. 5 is a flowchart illustrating a matching process in accordance with an embodiment of the present invention;

FIG. 6 is a flowchart illustrating an interacting process in accordance with an embodiment of the present invention; and

FIG. 7 is a flowchart illustrating a response responded by a client in accordance with an embodiment of the present invention.

### DETAILED DESCRIPTION OF THE PREFERRED EMBODIMENTS

### Terminology

The terminologies employed herein are for the purpose of description and should not be regarded as limiting.

Network: an infrastructure allowing devices to communicate and/or transmit data based on predetermined protocol via either wired of wireless communication link.

Server: a device in the network for providing specific services, such as a message server for exchanging message among clients or a database server for storing data.

Client: an apparatus allowing a user to access the service provided by the server via the network, such as a computer, a mobile phone, a PDA, etc.

<System Overview>

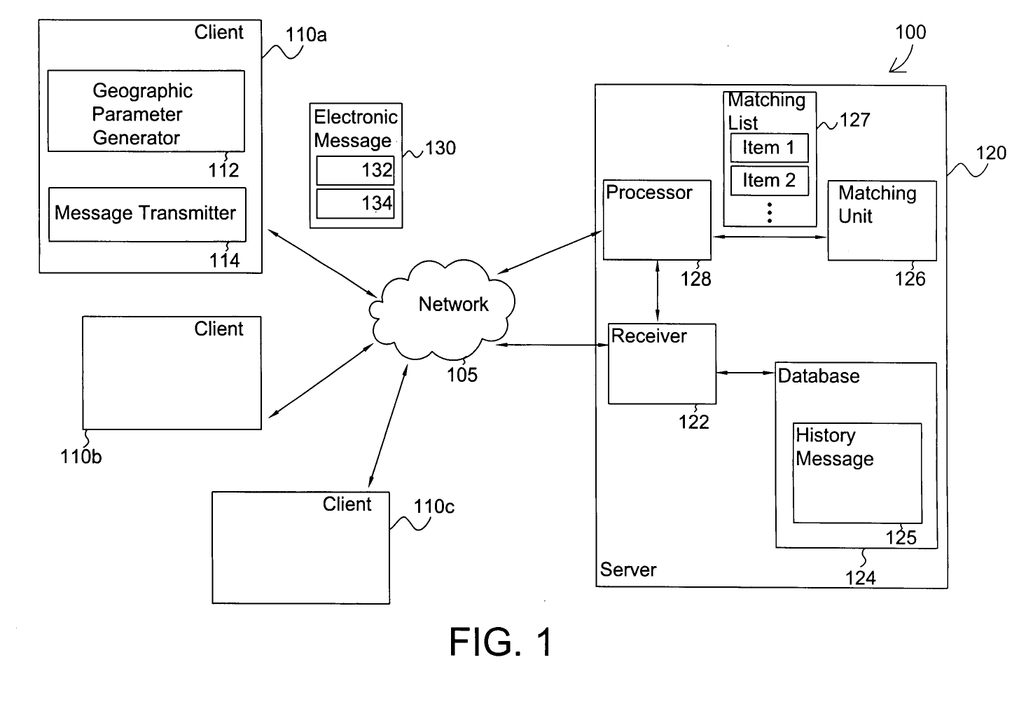

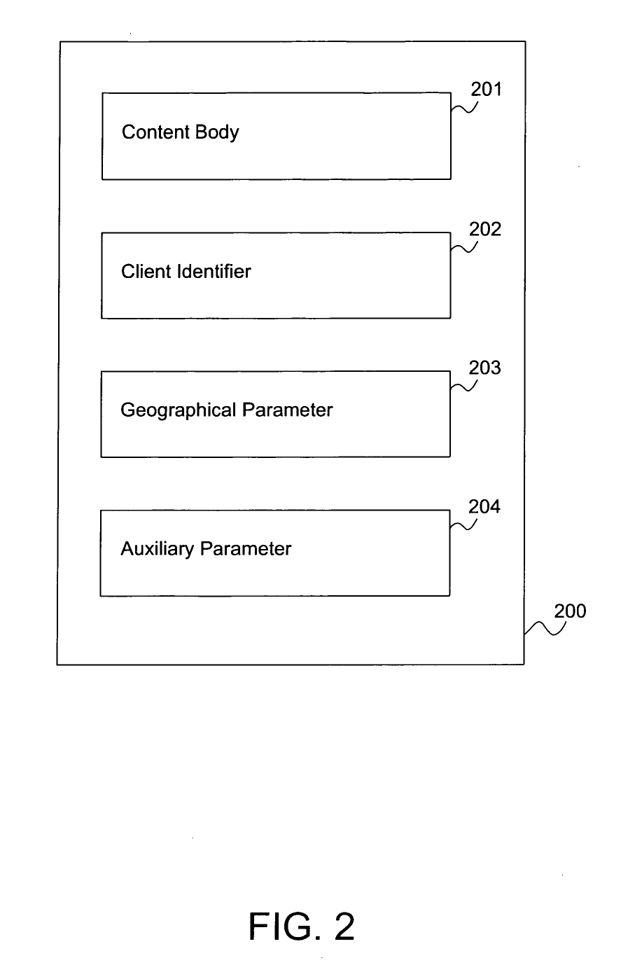

FIG. 1 illustrates a system 100 for asynchronously exchanging electronic messages in accordance with an embodiment of the present invention. The system 100 in a network 105 is configured to asynchronously exchange electronic messages among a plurality of clients (such as clients 110a, 110b, and 110c). The system 100 includes a server 120 as shown in the drawing. The server 100 includes a receiver 122, a database 124, a matching unit 126, and a processor 128. The receiver 122 is configured to receive the electronic message from clients 110a, 110b, and 110c. It should be noted that, in this embodiment, it is described that the client 110a, also called “source client”, sends a message to the server 100, however, each of the clients 110a, 110b, and 110c may respectively send a message to the server 120 in other embodiments. Those who skilled in the art may understand that similar processes may be applied to client 110b or client 110c in other embodiments. Client 110a has a geographic parameter generator 112 and a message transmitter 114. The geographic parameter generator 112 is configured to generate a geographic parameter 134, such as the Global Positioning System (GPS) signal. The message transmitter 114 is configured to transmit the electronic message 130 including a content body 132 and the geographic parameter 134. For illustrative purpose, the electronic message 130 is briefly described here and will be discussed in detail in another embodiment as shown in FIG. 2.

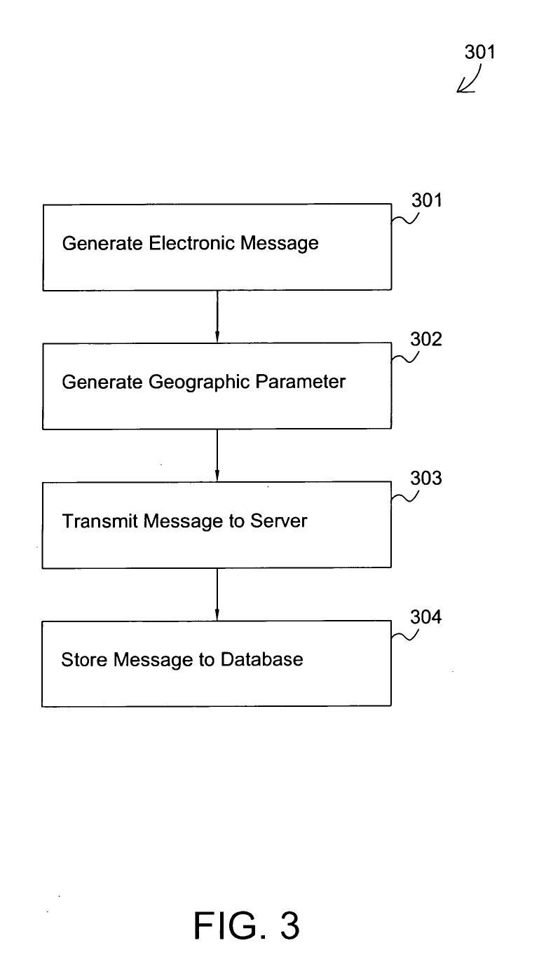

The message transmitter 114 of the client 110a sends the electronic message 130 to the server 120 through a network uploading process (such as sending packets based on TCP/IP protocol), the electronic message 130 is received by the receiver 122 and stored in the database 124 of the server 120. The details of the database 124 will be discussed later in references to FIG. 3. The matching unit 126 compares the geographic parameter 134 of the received message 130 to other existing electronic messages 125 stored in the database 124 according to a set of preset matching rules. The existing electronic messages 125, also called history messages herein, are the electronic messages previously uploaded by other clients. In this embodiment, according to the set of preset matching rules, it is determined whether the geographic parameter 134 of the received message 130 is matched to a geographic parameter of the existing electronic messages 125 stored in the database 124. If there are one or more of the history messages 125 determined as a match, the matched history messages 125 are recorded into a matching list 127. Based on the matching list 127, the processor 128 interacts with at least one of the clients corresponding to the matched history messages 125, which will be discussed later.

It should be noted that the structure shown in FIG. 1 is an exemplary embodiment rather than limitations to the present invention. For example, the system 100 may be embodied in a proprietary infrastructure or an open infrastructure to provide the features herein disclosed, such as a personal computer incorporated with some appropriate software programs.

Similarly, the receiver 122, the database 124, the matching unit 126, and the processor 128 may be a single integral circuit, such as a centralized computing architecture, or separate devices, such as a distributed computing architecture. The database 124 may be a memory device embedded in the server 120, such as a flash memory, hard drive, floppy disk, tape drive, optical drive, magneto-optic drive, etc. Alternatively, the database 124 may also be another storage server (not shown) physically separated from the server 120. The server 120 may access the data stored in the storage server to logically provide an integral service to the clients. In other embodiments, the database 124 may further include several subcomponents, such as a message storage unit and a user profile storage unit respectively for information of electronic messages and user profiles. Also, the present invention does not tend to limit the data structure in the database 124. For example, the database 124 is a relational database system in this embodiment, while other structure may also be used in other embodiments.

Furthermore, the clients 110a, 110b, 110c may communicates with the server 120 via various approaches, such as internet, Public Switched Telephone Network (PSTN), wireless network, local network, mobile network, etc. In other words, the present invention is not limited to specific computing architectures or hardware devices. Contrarily, any architecture capable of providing network communicating service may be applied to the present invention.

Other embodiments are described hereinafter to further discussing the present invention in detail so that those who skilled in the art may have a better understanding to various features and advantages of the present invention.

<Electronic Messages with Geographic Parameter>

FIG. 2 illustrates a structure of the electronic message 200 with the geographic parameter 203 in accordance with an embodiment of the present invention. In this embodiment, the electronic message 200 includes four items, i.e. a content body 201, a client identifier 202, the geographic parameter 203, and an auxiliary parameter 204. The content body 201 may includes text, pictures, video, and/or multimedia combination. The client identifier 202 allows the server identifies the client sending the message. For example, the client identifier 202 may be an e-mail address, a user name, a user number, etc. The geographic parameter 203 may, but not limit to, be automatically generated by the client or manually specified by the user. The auxiliary parameter 204 may be other available parameters, such as the date or time parameter automatically generated by the client or manually specified by the user. It should be noted that the embodiment described above is illustrated for the exemplary purpose rather than restrictions. The electronic message 200 may include more or less parameters in other embodiments. For example, the electronic message 200 may be embodied without the client identifier 202 or auxiliary parameter 204 in one embodiment, or alternatively the electronic message 200 may include other parameters in another embodiment.

<Network Uploading Process >

In this embodiment, the electronic message 130 is uploaded to the receiver 122 of the server 120 through the network uploading process, and then the message 130 is stored in the database 124. FIG. 3 is a flowchart illustrating an uploading process 300 in accordance with an embodiment of the present invention. First, in step 301, a user generates the electronic message 130, such as inputting the message 130 to the client device through a user interface. In step 302, the relevant geographic parameter is generated. For example, the geographic parameter may be specified by the user or automatically generated by the client device. Thereafter, in step 303, the message transmitter 114 (such as a transponder) transmits the message 130 through the network 128 and then the message 130 is received by the receiver 122 of the server 120. In step 304, the message 130 is stored in the database 124.

<Matching Unit>

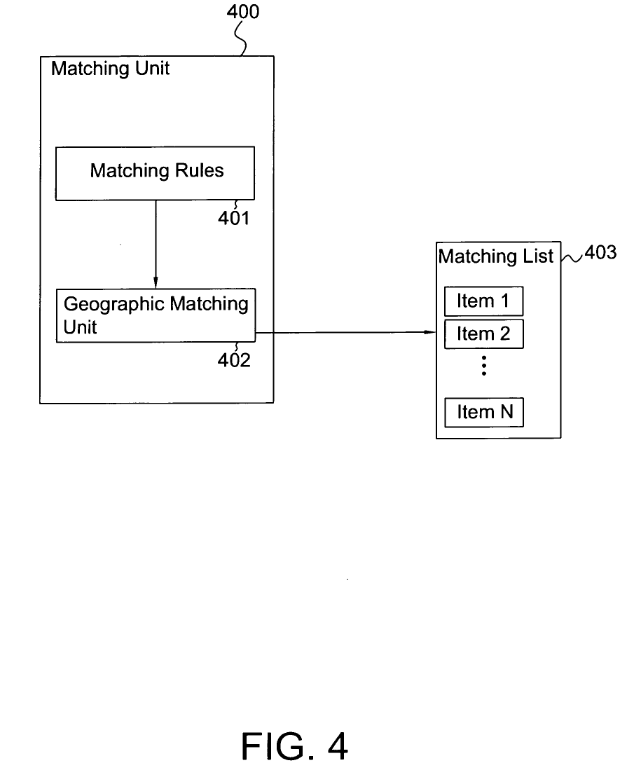

FIG. 4 illustrates a matching unit 400 in accordance with an embodiment of the present invention. The matching unit 400 includes a set of preset matching rules 401 and a geographic matching unit 402. The matching rule 401 may be previously determined, such as rules of geographic relevance (e.g. geographic coordinates) in this embodiment or rules of user relevance (e.g. gender of users) in another embodiment. When a new message is stored in the database 124, the geographic matching unit 401 performs a matching process. Therefore, all messages conforming to the preset matching rules 401 are recorded to generate a matching list 403, which is then sent to the processor 128 for further processing. The matching list 403 includes at least one item, each item corresponding to a client. As shown in FIG. 4, in this embodiment, the matching list 403 includes N items, each item representing a history message conforming to the preset matching rules 401 and information of the corresponding client.

The matching unit 400 is configured to compare the geographic parameter of the received message to other existing electronic messages stored in the database 124. Furthermore, based on the matching list 403, the processor 128 allows two or more anonymous users to communicate with each other. It should be noted that the geographic matching of the preset matching rules is merely an exemplary embodiment. Other matching rules may also be applied to the present invention, such as a matching rule for comparing the auxiliary parameter 204 in the electronic message 200, for example, comparing the date parameter of the electronic message.

<Matching Process>

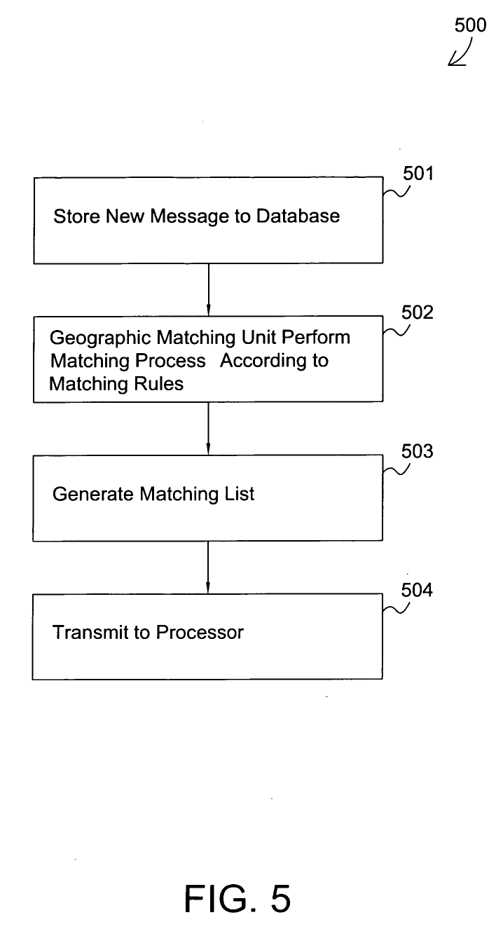

FIG. 5 is a flowchart illustrating a matching process 500 in accordance with an embodiment of the present invention. First, in step 501, a new message is stored in the database 124. Thereafter, in step 502, the geographic matching unit 402 compares the new message to the existing messages stored in the database 124 according to a set of preset matching rules 401. In step 503, all messages conforming to the preset matching rules 401 are recorded to generate a matching list 403. In step 504, the matching list 403 is sent to the processor 128 for further processing.

<Processor and Interaction>

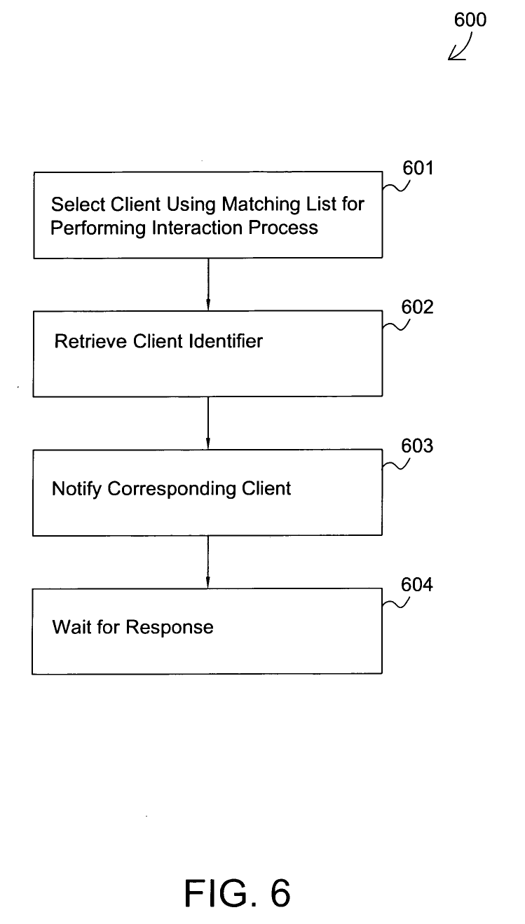

FIG. 6 is a flowchart illustrating an interacting process 600 in accordance with an embodiment of the present invention. When electronic messages are successfully matched, the processor 128 may communicate with at least one client.

In the present invention, the interaction may be performed in various approaches, such as one of the exemplary embodiment shown in FIG. 6. In step 601, the processor 128 selects one or more clients, conforming to the preset matching rules 401, listed in the matching list 403 for the interaction process. In step 602, the client identifier 202, such as the default communication path for the selected client, is retrieved. In step 603, the processor 128 sends a notification to the selected client according to the client identifier 202. In step 604, the server 120 waits for a response for the selected client.

<Client Response>

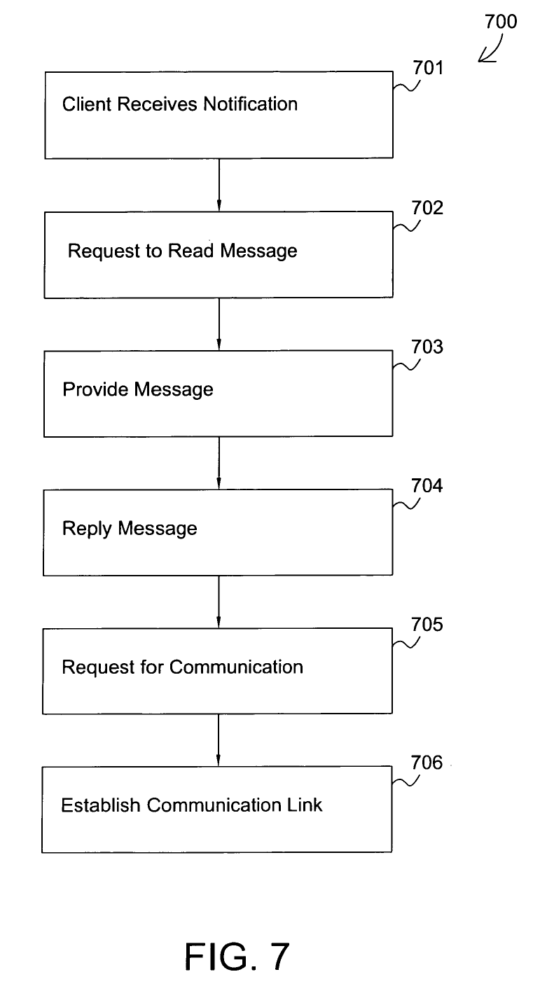

When the selected client receives the notification, the user may determine to perform possible responses. For example, the user may choose to read the electronic message corresponding to the notification, or send a reply message to the server 120. FIG. 7 is a flowchart illustrating a response process 700 performed by a client in accordance with an embodiment of the present invention.

In step 701, the client receives the notification sent by the processor 128. In step 702, the client sends a request to read the message. In step 703, the processor 128 provides the electronic message to the client, or alternatively provides a portion of or the entire matching list 403 to the client. In step 704, the client may determine whether to reply the received electronic message. In step 705, the client may selectively send a request for communication. The processor 128 may selectively provide communication information to the corresponding client in response to the request. In step 706, a communication link may be established between the clients. It should be noted that the embodiment described above is illustrated for exemplary purpose rather than restrictions. In other embodiments, for example, the client may selectively perform some of step 702 to step 706, or perform them in different orders.

In the above embodiments, the client sending the electronic message (i.e. the source client) and the client receiving the message (i.e. the corresponding client) are illustrated for exemplary purpose. There are still various modifications and changes still fallen within the scope of the present invention. For example, when the source client sends the electronic message to the server and the server generates the matching list, the server may interact with the source client and/or the corresponding client, e.g. sending the matched history messages to the source client. Similarly, the source client may perform various responses to the server as well.

By means of the method and system disclosed by the present invention, the client may utilize the geographic parameter generator, such as a GPS positioning unit, to generate an electronic message with geographic parameter. The server is configured to receive at least one electronic message and store the message in a database. The user may use the message transmitter to transmit the electronic message, including the user identifier, text, pictures, video, audio, geographic parameter, etc, to the server. The server may perform the matching process according the geographic parameter based on the set of preset matching rules. Thereafter, the server may selectively and respectively send a notification to one or more corresponding clients. By this message exchange method, the users having some common characteristics (i.e. conforming to the matching rules) may communicate with each other based on the matching process by the server even if the users are not known to each other. The users may still anonymously communicate with each other via the server thereafter, or alternatively establish a direct communication link, such as e-mail or telephone.

The spirit and scope of the present invention can be clearly understood by the above detail descriptions of the prefer embodiments. The embodiments are not intended to construe the scope of the invention. Contrarily, various modifications of the illustrative embodiment, as well as other embodiments of the invention, will be apparent to persons skilled in the art upon reference to this description. It is therefore contemplated that the appended claims will cover any such modifications or embodiments as falling within the true scope of the invention.

We claim:

1. A method for asynchronously exchanging electronic messages in a network, the method comprising the following steps:
receiving an electronic message from a source client, the electronic message having a content body and a geographic parameter;
storing the received electronic message into a database;
comparing the geographic parameter of the received message to other existing electronic messages, each of the existing electronic messages corresponding to a client, stored in the database according to a set of preset matching rules to determine whether there is a match;
generating a matching list if the match is determined; and
interacting with at least one of the corresponding clients in the matching list.

2. The method according to claim 1, wherein the set of preset matching rules includes determining whether the geographic parameter of the received message matches a geographic parameter of the existing electronic messages stored in the database.

3. The method according to claim 1, wherein the matching list includes a plurality of items, each item corresponding to a client, and wherein the step of interacting with the at least one of the corresponding clients further comprising:
transmitting a notification to at least one of the corresponding clients according to the plurality of items of the matching list; and
receiving one or more responses from the at least one of the corresponding clients.

4. The method according to claim 3, wherein the response from the at least one of the corresponding clients is a replied electronic message, and wherein the method further comprises:
transmitting the replied electronic message to the source client; and
receiving a response from the source client.

5. The method according to claim 3, wherein the response from the at least one of the corresponding clients is a request for communication, and wherein the method further comprises:
selectively providing a communication information to the at least one of the corresponding clients for establishing a communication link between the at least one of the corresponding clients and the source client.

6. The method according to claim 5, wherein the electronic message further comprises a client identifier, and wherein the communication information further comprises the client identifier for the at least one of the corresponding clients to establish the communication link.

7. The method according to claim 1, wherein the geographic parameter is a global positioning system (GPS) signal.

8. The method according to claim 1, wherein the electronic message further comprises a date parameter, and wherein the set of preset matching rules further includes determining whether the date parameter of the received message matches a date parameter of the existing electronic messages stored in the database.

9. A system for asynchronously exchanging electronic messages in a network, the system comprising:
a plurality of clients, each client having:
a geographic parameter generator configured to generate a geographic parameter; and
a message transmitter configured to transmit an electronic message having a content body and the geographic parameter;
a server, including:
a receiver configured to receive the electronic message from a source client of the plurality of clients;
a database configured to store the received electronic message;
a matching unit configured to compare the geographic parameter of the received message to other existing electronic messages stored in the database according to a set of preset matching rules to determine whether there is a match and generate a matching list if the match is determined; and
a processor configured to interact with at least one of the clients in the matching list.

10. The system according to claim 9, wherein the set of preset matching rules includes determining whether the geographic parameter of the received message is matched to a geographic parameter of the existing electronic messages stored in the database.

11. The system according to claim 9, wherein the matching list includes a plurality of items, each item corresponding to a client, and wherein the processor is further configured to transmit a notification to at least one the corresponding clients according to the plurality of items of the matching list, and the receiver is further configured to receive one or more responses from the at least one of the corresponding clients.

12. The system according to claim 11, wherein the response from the at least one of the corresponding clients is a replied electronic message, and wherein the processor is further configured to transmit the replied electronic message to the source client, and the receiver is further configured to receive a response from the source client.

13. The system according to claim 11, wherein the response from the at least one of the corresponding clients is a request for communication, and wherein the processor is further configured to selectively provide a communication information to the at least one of the corresponding clients for establishing a communication link between the at least one of the corresponding clients and the source client.

14. The system according to claim 13, wherein the electronic message further comprises a client identifier, and wherein the communication information further comprises the client identifier for the at least one of the corresponding clients to establish the communication link.

15. The system according to claim 9, wherein the geographic parameter is a global positioning system (GPS) signal.

16. The system according to claim 9, wherein the electronic message further comprises a date parameter, and wherein the set of preset matching rules further includes determining whether the date parameter of the received message matches a date parameter of the existing electronic messages stored in the database.
